(19) United States
(12) Patent Application Publication
(10) Pub. No.: US 2022/0197270 A1
(43) Pub. Date: Jun. 23, 2022

(54) SYSTEMS AND METHODS FOR DATA ANALYTICS AND FAULT DETECTION IN EQUIPMENT

(71) Applicant: Bernhard TME, Little Rock, AR (US)

(72) Inventors: Stephen Heard, Fayetteville, AR (US); Zach Mierzejewski, Saint Louis, MO (US); Rachel Poff, Little Rock, AR (US)

(21) Appl. No.: 17/481,421

(22) Filed: Sep. 22, 2021

Related U.S. Application Data
(60) Provisional application No. 63/208,823, filed on Jun. 9, 2021.
(60) Provisional application No. 63/128,517, filed on Dec. 21, 2020.

(51) Int. Cl. G05B 23/02; G16Y 20/30; G16Y 10/80

(52) U.S. Cl. CPC G05B 23/0235; G16Y 10/80; G16Y 20/30; G05B 23/0275

(57) ABSTRACT

A system for monitoring a piece of equipment is provided to enable determination of a fault state of the piece of equipment based on data about the piece of equipment and data about other equipment. Also provided are a method of monitoring a piece of equipment and a computer-readable medium including instructions for monitoring a piece of equipment.

### CROSS REFERENCE TO RELATED APPLICATIONS

This application claims the benefit of U.S. Provisional Application No. 63/128,517, filed Dec. 21, 2020 and U.S. Provisional Application No. 63/208,823, filed Jun. 9, 2021, the disclosure of each of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 schematically illustrates a system for monitoring a piece of equipment, according to aspects of the present disclosure.

FIG. 2 is a schematic representation of a Config database, according to aspects of the present disclosure.

FIG. 3 is a schematic representation of a flow of data, according to aspects of the present disclosure.

FIG. 4 is a schematic representation of a data flow, according to aspects of the present disclosure.

FIG. 5 is a schematic representation of a data flow, according to aspects of the present disclosure.

FIG. 6 is a schematic representation of a set of data flows, according to aspects of the present disclosure.

FIG. 7 is a schematic representation of calculators, according to aspects of the present disclosure.

FIG. 8 is a schematic representation of operations of a fault calculator, according to aspects of the present disclosure.

FIG. 9 is a schematic illustration of spawning a configuration-based calculation, according to aspects of the present disclosure.

FIG. 10 is a block diagram of an example system for data analytics and fault detection in equipment, according to aspects of the present disclosure.

FIG. 11 is a flow diagram of an example method for data analytics and fault detection in equipment, according to aspects of the present disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

A significant percentage of total energy consumption may be by equipment (e.g., climate control systems, electrical systems, information technology systems, etc.) located in commercial and residential buildings. An increasing complexity and/or amount of such equipment may introduce difficulties in equipment fault detection and/or remediation of detected equipment faults. Furthermore, with rising energy costs, increasing interest in efficiency, and growing concerns about climate change, it may be increasingly important to monitor and/or reduce equipment energy consumption.

However, it may be difficult to collect, track, and/or analyze facility and/or equipment data to provide useful, actionable insights regarding facility and/or equipment status and/or operation. Hence, the present application identifies and addresses a need for improved systems and methods for data analytics and fault detection in equipment.

The present disclosure is generally directed to systems and methods for data analytics and fault detection in equipment. As will be explained in greater detail below, embodiments of the instant disclosure may obtain a datum relevant to an operation of a piece of equipment and may calculate a blocking rule for the piece of equipment. Embodiments may also determine, based on the calculation of the blocking rule, whether to calculate at least one detection rule for the piece of equipment, and may determine a fault state of the piece of equipment based on the calculation of the blocking rule, the calculation of the detection rule, and a calculation of an enabling rule for the piece of equipment. In some examples, the calculation of the blocking rule, the calculation of the detection rule, and/or the calculation of the enabling rule may be based on the datum.

Embodiments of the present disclosure may provide an analysis and fault detection platform that may collect, track, and/or perform automatic analysis on equipment (e.g., blowers, chillers, and valves in a facility). Embodiments may further use this operational data to provide data-driven insights and detect problems in equipment operation. Embodiments disclosed herein may include processing systems, cloud storage and processing, and a user interface for interacting with the provided embodiments.

In some examples, embodiments of the present disclosure may provide data acquisition techniques as a function. Disclosed embodiments may include an ability to integrate and collect data from many sources. In additional examples, the collected data may be transferred to a cloud-based storage system so that end users can access all of the collected data regardless of the source.

In some embodiments, the data may be collected using an Internet of Things (loT) data collection device that may integrate with building automation systems (BAS) of a facility, extract equipment operational data, and transmit the data to the cloud for storage and processing.

Some embodiments of the present disclosure may be capable of collecting data using software-based integrations and/or application programming interfaces (APIs). For example, some embodiments may use software-based integrations and/or APIs to collect weather data, synchronize with existing databases of equipment, and/or receive data from existing automation processes.

In some embodiments, collected data may be transformed into a format that is consistent across all systems of the embodiments. After such a transformation, a map of the data may be created by organizing the data into facilities, systems, and equipment. In some examples, once the data is transformed and organized, automated calculations may provide continuous real time insights based on data regarding equipment that arrives.

In some examples, all data, regardless of whether it is original data collected from an integration or data generated by a calculation performed by an embodiment of the present disclosure, may be made available to end users for display (e.g., visual display) and/or analysis via a user interface. In some embodiments, data may be generated based on calculations, iterations of calculations, and/or algorithms that are able to detect fault conditions, prioritize the fault conditions, and/or generate and provide information associated with the fault conditions and any recommended remedial action.

In some embodiments of the present disclosure, after the data has been transformed and organized, one or more elements included in one or more of the systems disclosed herein may perform specialized analysis to detect fault conditions in the monitored equipment. This process may be referred to herein as Automated Fault Detection. Systems including embodiments of the present disclosure may monitor for many (e.g., hundreds, thousands, etc.) of fault conditions simultaneously and may automatically alert equipment operators when a fault condition is detected.

Embodiments of the present disclosure may utilize data structures and may calculate rules stored in a library of data structures and fault detection rules. Aspects of the present disclosure may enable flexible configuration of fault detection rules and/or detected faults while increasing quality control of the fault detection rules and/or the detected faults. Aspects of the present disclosure may reduce detections of false or duplicate faults and may help with diagnosing the root cause of detected and/or identified faults.

Aspects of the present disclosure may also enable fault status of equipment to be used throughout the embodiments of the present disclosure such as in reports, dashboards, and/or charts alongside other collected and calculated data.

Embodiments of the present disclosure may also include robust features for tracking, analyzing, and presenting utility and energy data (e.g., utility and energy consumption of a facility) in parallel with real-time operational data. These features may provide users with a complete picture of a facility's energy use and cost.

Embodiments of the present disclosure may provide weather normalized reporting for equipment or a facility, energy baseline comparisons for the equipment or the facility, and/or performance scorecards for the equipment or the facility. The scorecards may track energy savings on a daily, monthly, and/or other periodic basis, and may demonstrate an impact of energy conservation projects and other operational changes to a piece of equipment or a facility. In some embodiments, users may also visually display utility invoice data, compare against budgets, analyze invoiced data for billing errors, and/or track key process indicators (KPls) such as energy use intensity (EUI).

Embodiments of the present disclosure may include a user interface. Some of the main components of the user interface may include, without limitation, charting, dashboarding, and/or reporting features. A charting feature may provides a user with the ability to perform deep analysis of data streams, diagnose the root cause of faults, discover anomalies in operation and energy consumption, and identify opportunities for cost savings. A dashboard feature may summarize and present data with simple, easy to read visual presentations. Finally, a reporting feature may document data and streamline communication of information to the user.

Embodiments of the present disclosure may automatically collect data regarding equipment and facilities, automatically detect problems with equipment and facilities, track utility bills, and show data graphically through dashboards and reporting.

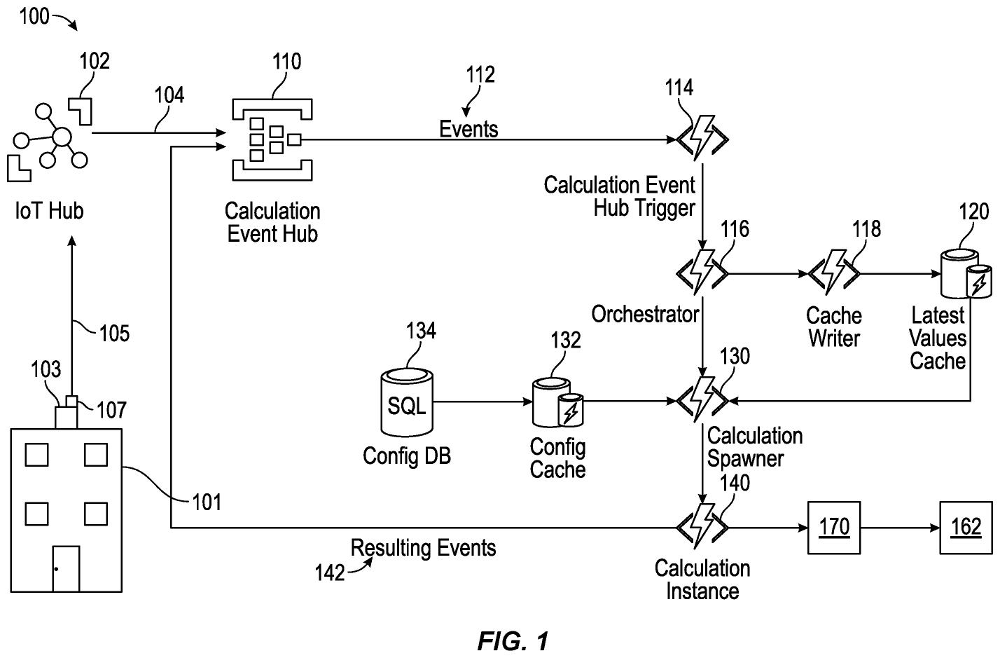

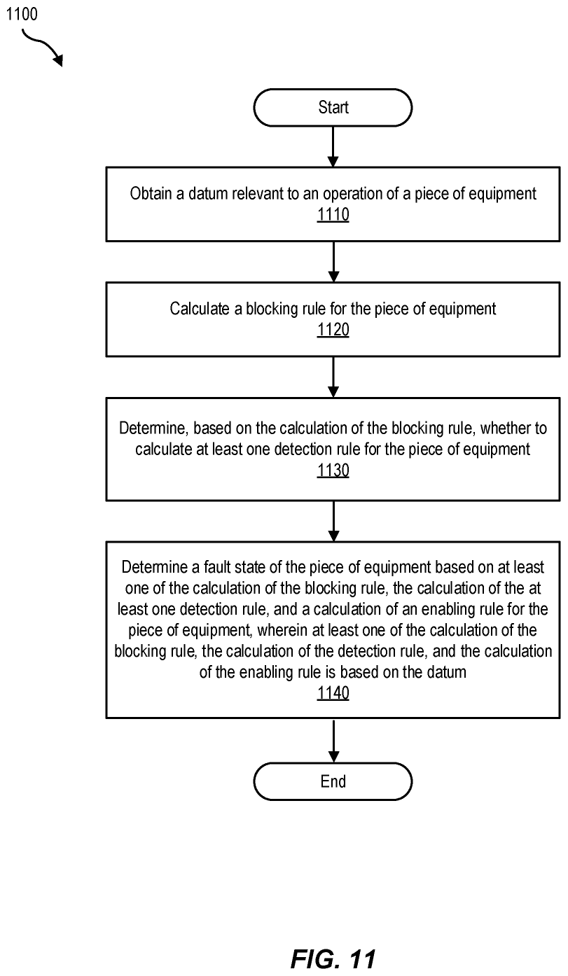

The following will provide, with reference to FIGS. 1-10, detailed descriptions of systems for data analytics and fault detection in equipment. Detailed descriptions of corresponding computer-implemented methods will also be provided in connection with FIG. 11.

FIG. 1 schematically illustrates a system 100 according to aspects of the present disclosure. As will be described in greater detail below in reference to FIGS. 10 and 11, FIG. 1 may represent an implementation of a system for data analytics and fault detection in equipment. The system 100 may include software and hardware components that may include an IoT hub 102, a calculation event hub 110, a calculation event hub trigger 114, an orchestrator 116, a cache writer 118, a latest values cache database 120, a calculation spawner 130, a configuration cache database 132 (also “config cache database 132” herein), a configuration database 134 (also “config database 134” herein), and a calculation instance 140.

IoT hub 102 may obtain data 105 from an instrument 107 monitoring a piece of equipment 103, which may, for example, be a machine or appliance (e.g., a blower, heater, or chiller) in a building 101. The data 105 may be, for example, an air temperature, a water temperature, a rotational speed of a motor in the piece of equipment 103, a flow rate of air through the piece of equipment 103, a flow rate of water through the piece of equipment 103, a valve position (e.g., fully open, fully closed, or an indication of percent open of the valve).

IoT hub 102 may transform the data and pass the transformed data 104 to the calculation event hub 110. Transformation of the data may include, for example, converting an electrical signal into a numerical measurement (e.g., to a temperature in ° F. or an air flow rate in cubic feet per minute (CFM)), and placing the numerical measurement into a data structure (e.g., a vector, matrix, database, or other software object) with an identifier of the piece of equipment 103 and a timestamp of when the data 105 was obtained.

Calculation event hub 110 may determine that the transformed data 104 represents a change from a previous value of the data 105, raise an event 112 corresponding to the change, and send the event 112 to the calculation event hub trigger 114.

Calculation event hub trigger 114 may indicate to orchestrator 116 that the event 112 indicates the transformed data 104 is a change, triggering one or more calculations. The orchestrator 116 may send the transformed data 104 to the cache writer 118, which may cause the transformed data 104 to be written in the latest values cache database 120. The orchestrator 116 may also indicate to the calculation spawner 130 a set of calculations that may use the transformed data 104 and an order in which the set of calculations should be executed.

Calculation spawner 130 may retrieve a configuration for each calculation of the set of calculations from the config cache database 132, which may retrieve the configuration from the config database 134. A configuration for a calculation may, for example, specify to perform an XYZ calculation on points A, B, and C, and the result will be an event for point D. Calculation spawner 130 may spawn a calculation instance 140, if the calculation depends on the transformed data 104 and the latest values cache database 120 contains values for all of the calculation's dependencies. That is, if one of points A, B, and C is unknown (e.g., has no value in the latest values cache), then the calculation spawner 130 will not spawn a calculation instance 140 for the XYZ calculation. The calculation spawner 130 may, for example, use config and metadata to decide which calculator to use in a calculation instance. A calculation instance 140 may take in the transformed data 104 and other data from the latest values cache 120 and output resulting events 142 that may be passed to the calculation event hub 110, possibly resulting in additional calculations being triggered and performed as described above.

Events are an example output of a calculation, and a calculation may have other types of outputs (e.g., data or reports). For example, calculated points may go back into the system, allowing cascading calculations. The calculation instance may also generate one or more fault reports 170, which may be stored in a fault store 162.

Referring to FIG. 1, an example of operations that may be performed by the system 100 will now be described. An instrument 107 (e.g., a thermometer) monitoring the piece of equipment 103 (e.g., a chiller) may send data 105 (e.g., a water temperature) regarding the piece of equipment to the IoT hub 102. The instrument 107 may, for example, send the data 105 via a wireless network, a wired network, or an infrared signal.

IoT hub 102 may transform the water temperature by combining the water temperature with an identifier (e.g., a correlation ID) of the chiller 103, a timestamp, and an identifier for the event (e.g., a time series ID) and then send the transformed data 104 to the calculation event hub 110. The IoT hub 102 may send the transformed data via, for example, a wireless network, a wired network, or an infrared signal. The calculation event hub 110 determines the transformed data 104 represents a change from a previous value (e.g., a change in the water temperature of the chiller 103), raises a corresponding event 112 (e.g., “is water temperature of chiller 103 in correct range?” event) in the system 100, and sends the event 112 to the calculation event hub trigger 114.

Calculation event hub trigger 114 may indicate to orchestrator 116 that the transformed data 104 is a change triggering one or more calculations. The triggered calculations may include, for example, “is water temperature of chiller 103 in correct range?” and “should temperature check of room 1 be disabled?”

Orchestrator 116 may send the transformed data 104 to the cache writer 118, which may cause the transformed data to be written in the latest values cache database 120. Orchestrator 116 may also indicate to the calculation spawner 130 a set of calculations (e.g., “is water temperature of chiller 103 in correct range?” and “should temperature check of room 1 be disabled?”) that may use the transformed data and an order (e.g., calculate “is water temperature of chiller 103 in correct range?” before calculating “should temperature check of room 1 be disabled?”) in which the set of calculations should be executed.

Calculation spawner 130 may retrieve a configuration (e.g., a rule that causes a fault to be reported when the water temperature for chiller 103 is too high) for each of the calculations from the config cache database 132, which may retrieve the configurations from the config database 134. The configuration for “is water temperature of chiller 103 in correct range?” may, for example, specify to compare the most recent water temperature for chiller 103 to an optimal temperature for the water, based on outside air temperatures, interior air temperatures, and a time of day, and the result may be an event and potentially a fault report. The configuration for “should temperature check of room 1 be disabled?” may, for example, specify to disable the temperature check of room 1 when a fault has been reported for the chiller 103. A calculation instance 140 calculating “is water temperature of chiller 103 in correct range?” compares the temperature from the latest values cache (i.e., the temperature from the transformed data 104) with the correct range, which is determined based on the configuration of the rule retrieved from the config cache database 132. If the calculation instance 140 determines the water temperature of chiller 103 is outside of the correct range, then the calculation instance 140 outputs resulting events 142 that may be passed to the calculation event hub 110, possibly resulting in additional calculations being performed as described above. The calculation instance 140 may also generate a fault report 170 (e.g., chiller 103 water temperature is too high) to be stored in the fault store 162.

Embodiments of the present disclosure may enable automatic monitoring of a piece of equipment and may determine a fault state of the piece of the equipment. The disclosed systems and methods may also reduce reporting of faults that are caused by other faults, enabling quicker diagnosis of root causes of failures of systems of monitored equipment. For example, a system including embodiments of the present disclosure may determine that a blower motor has failed and may raise a fault for the failed blower while preventing reporting of temperatures being out of range for rooms that rely on the blower for ventilation.

In some examples, a “Fault Instance” may be a configuration of a fault, which may be a defined set of rules for evaluating fault status on a piece of equipment. Such a configuration may be stored in and obtained from the config database 134 (see FIG. 1).

In some embodiments, “Fault Status” may refer to an evaluation of whether a piece of equipment has been determined to have a fault and may have one of four values including: NOT FAULT, FAULT, BLOCKED, and DISABLED. Such a fault status may be included in a fault report 170 (see FIG. 1).

In some embodiments of the present disclosure, a “Fault Calculation” may be performed inside a calculator component (e.g., calculation instance 140, see FIG. 1) and may include reading a Fault Instance configuration from a config database 134, evaluating rules included in the Fault Instance, and outputting a Fault Report 170 to a Fault Store 162 of the system (see FIG. 1). The Fault Calculation may also output a calculated fault status into the system for use in other calculations.

In some examples, a “Fault Report” 170 may be the output of a single Fault Calculation (e.g., calculation instance 140, see FIG. 1). The Fault Report 170 may include a timestamp, a Fault Status, and additional metadata.

In embodiments of the present disclosure, a “Fault Store” 162 may be a system that receives fault reports 170, processes the fault reports 170, caches results of processing of the fault reports, and answers questions regarding Fault Reports 170 from other components (e.g., from a front end). The Fault Store 162 can return Fault Reports 170 and Current Fault States.

In some embodiments, Fault Store 162 may generate a “Current Fault State” by analyzing and aggregating the fault reports 170 the Fault Store has received. A Current Fault State may be a snapshot at the current point in time and may have similar data as a fault report, but with aggregated data added, such as how long the fault has been in the current status (such as FAULT), how often the fault changes, and the average length of time the fault stays in a status.

As used herein, a “pipeline” may include a stream of flow of data that may be used by systems including embodiments of the present disclosure. Thus, if a datum is placed in “the pipeline,” then that datum may be acted on by a calculation event hub, which may in turn cause a cascade of calculations to occur. For example, events 142 and transformed data 104 are added to the pipeline and processed by calculation event hub 110 to trigger additional calculations (see FIG. 1 and description above).

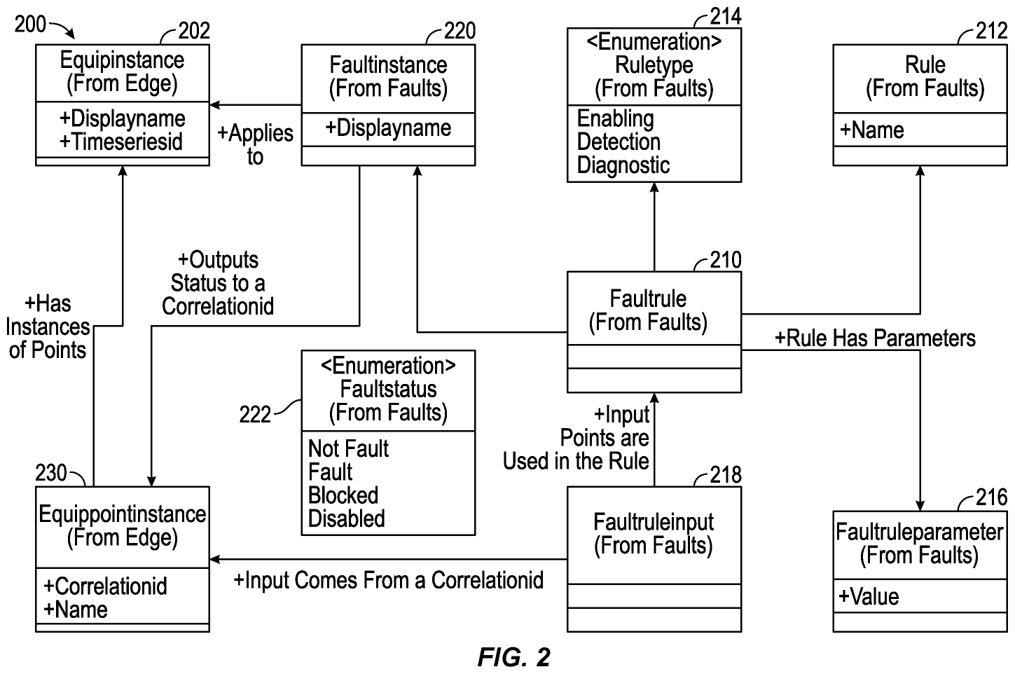

FIG. 2 is a schematic representation of a configuration database 200 (also “Config database 200” herein), according to some aspects of the present disclosure. The config database 134 shown in FIG. 1 may be an example of such a config database 200. As shown, config database 200 may include an Equipinstance table 202, a FaultRule table 210, a Rule table 212, a RuleType table 214, a FaultRuleParameter table 216, a FaultRulelnput table 218, a Faultlnstance table 220, a FalutStatus table 222, and an EquipPointlnstance table 230.

According to some aspects of the present disclosure, inputs from the FaultRuleInput table 218 that correspond to a piece of equipment may be written to entries in the EquipPointInstance table 230 that correspond to that piece of equipment. Similarly, inputs from the FaultRulelnput table 218 that correspond to a Fault Rule are written to entries in the FaultRule table 210 that correspond to that piece of equipment. Data from the FaultRule table 210 may be used in the Rule table 212, the FaultRuleParameter table 216, and the FaultInstance table 220. Data from the FaultInstance table 220, including values selected from the FaultStatus table 220, may be supplied to the EquipPointInstance table 230 and the Equipinstance table 202. Fault instances may be included and/or configured in the FaultInstance table 220, while fault statuses may be included and/or configured in FaultStatus table 222.

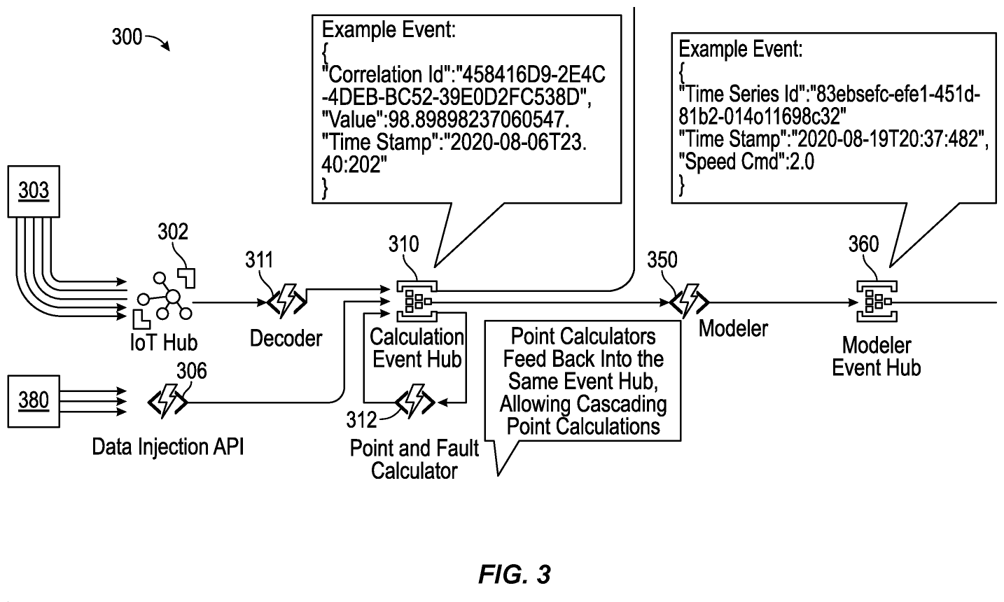

FIG. 3 is a schematic representation of a data flow 300, according to aspects of the present disclosure. The data flow 300 may be representative of a possible flow of data from a piece of equipment (e.g., equipment 103) to the IoT hub 102, from the IoT hub 102 to the calculation event hub 110, and to the calculation event hub trigger 114 (see FIG. 1). Data regarding a piece of equipment (e.g., piece of equipment 303) may be obtained by an IoT hub 302. The IoT hub 302 may be an example of an IoT hub 102 (see FIG. 1). The IoT hub 302 may send the obtained data to a decoder 311, which may transform the data and may send the transformed data to a calculation event hub 310.

The calculation event hub 310 may be an example of a calculation event hub 110 (see FIG. 1). Some outputs from the calculation event hub 310 may be sent to a point and fault calculator 312 and used in one or more point calculations. Outputs from the point and fault calculator 312 may be sent to the calculation event hub 310 for use in further calculations. Data regarding weather, utility costs, or other types of data may be obtained by a data injection application programming interface (API) 306, which may obtain the data from a front end, controller, or other instrument 380, transform the data, and supply the transformed data to the calculation event hub 310.

Some outputs from the calculation event hub 310 may be supplied to a modeler 350, which may supply outputs to a modeler event hub 360. Modeler hub 360 may, in turn, supply a time series ID to the modeled events, such that a calculation event hub or calculation instance may identify and refer to particular events via the time series ID when triggering events and performing calculations. A fault report 170 and fault store 162 may also refer to events by their time series IDs for analysis of faults, for example.

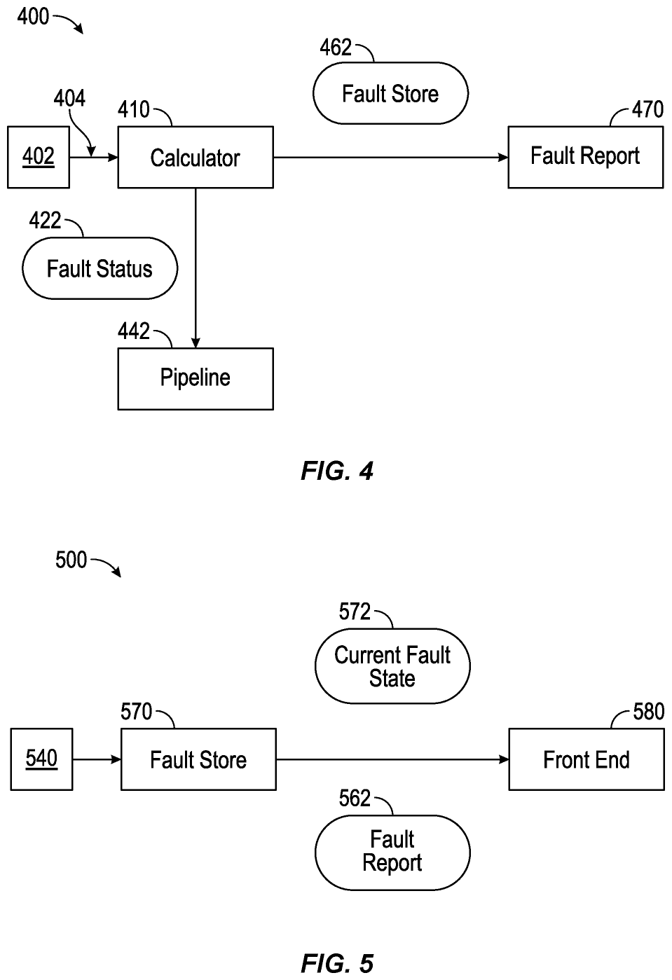

FIG. 4 is a schematic representation of a data flow 400, according to aspects of the present disclosure. As shown in the data flow 400, a calculator 410 may obtain transformed data 404 from an IoT hub or other source 402 and may calculate one or more rules. The calculation of the rule(s) may cause updates to a fault Status 422. This may result in calculator 410 causing a fault report 462 to be recorded in the fault store 470. Calculator 410 may also send a fault status 422 into the pipeline, which may result in spawning of one or more other calculations when a calculation event hub, such as calculation event hub 110 (see FIG. 1), receives the fault status 422.

FIG. 5 is a schematic representation of a data flow 500, according to aspects of the present disclosure. In the data flow 500, a fault store 570 may obtain a calculation result indicating a fault from a calculation instance 540 and may provide a current fault state 572 and a fault report 562 to a front end 580 for presentation to a user. The fault store 570 may provide the current fault state 572 and/or the fault report 562 to the front end 580 in response to a query from the front end 580. That is, the front end 580 may read from the fault store 570.

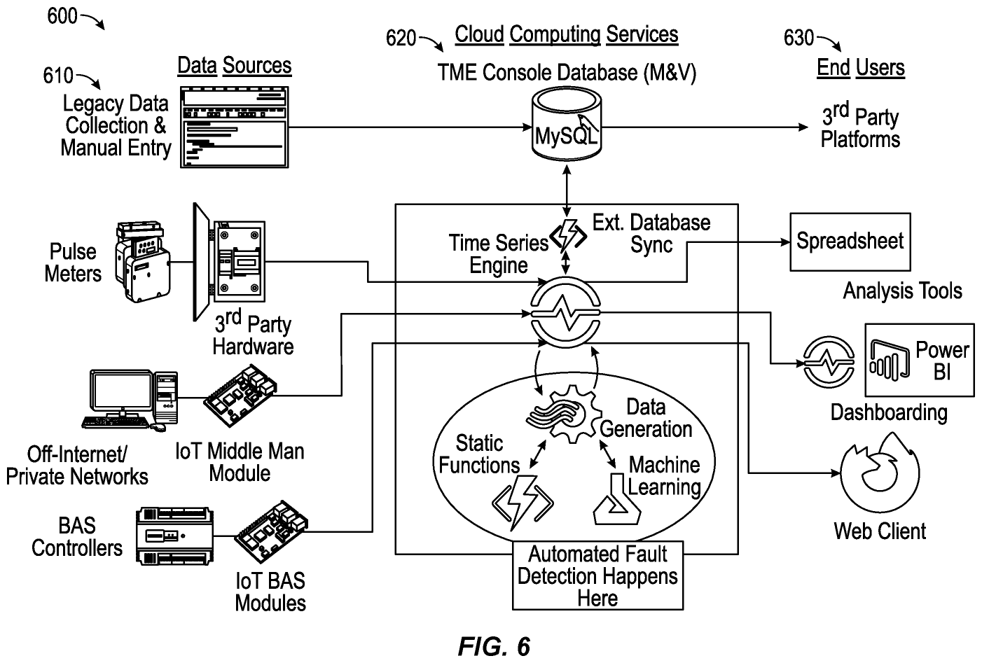

FIG. 6 is a schematic representation of a set of data flows 600, according to aspects of the present disclosure. As illustrated in FIG. 6, one or more cloud computing services 620 (e.g., a console database, a time series engine, or a monitoring system) may receive data from one or more data sources 610 (e.g., data collection devices, meters, IoT middle man modules, and IoT BAS modules).

In some implementations, the data sources 610 may be examples of the instrument 107 (see FIG. 1). The cloud computing services 620 may be implementations of the calculation event hub 110, calculation event hub trigger 114, orchestrator 116, cache writer 118, latest values cache database 120, calculation spawner 130, config cache database 132, config database 134, and calculation spawner 140 (see FIG. 1). The computing services 620 may present data to end user tools 630 (e.g., analysis tools, dashboards, or a web client), which may be implementations of the fault store 162 (see FIG. 1).

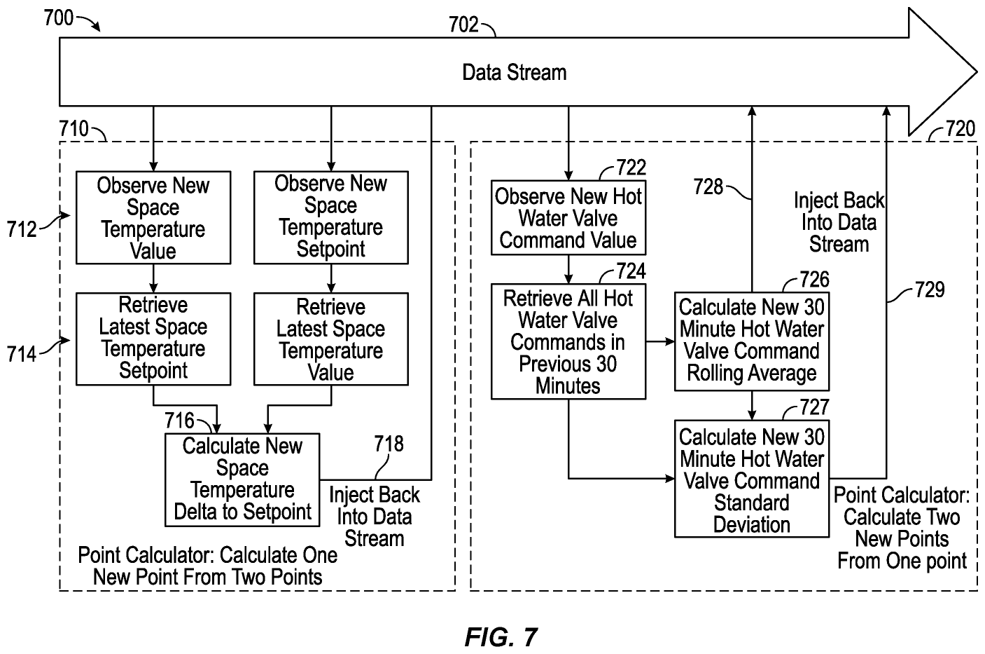

FIG. 7 is a schematic representation of calculators 700, according to aspects of the present disclosure. Calculators 700 may be implementations of calculation event hub trigger 114, orchestrator 116, calculation spawner 130, and/or calculation spawner 140 (see FIG. 1). At 712, calculator 710 may observe (e.g., based on output from a calculation event hub, such as the calculation event hub 110 (see FIG. 1)) that there is a new space temperature value and a new space temperature setpoint from a data stream 702 (e.g., a pipeline). At 714, the calculator 710 may retrieve (e.g., from the latest cache values database 120 (see FIG. 1)) the latest space temperature setpoint and the latest space temperature value. At 716, the calculator 710 may calculate a new space temperature to setpoint delta, based on the latest space temperature setpoint and the latest space temperature value. At 718, the calculator 710 may inject the new space temperature to setpoint delta back into the data stream 702, where it may be used by other calculators.

At 722, calculator 720 may observe (e.g., based on output from a calculation event hub, such as the calculation event hub 110 (see FIG. 1)) that there is a new hot water valve command value from the data stream 702. At 724, the calculator 720 may retrieve (e.g., from the latest cache values database 120 (see FIG. 1)) all hot water command values for the previous 30 minutes, which includes the new hot water valve command value. At 726, the calculator 720 may calculate a new 30 minute hot water valve command rolling average, based on the hot water command values for the previous 30 minutes. At 728, the calculator 720 may inject the new 30 minute hot water valve command rolling average back into the data stream 702, where other calculators may use the new 30 minute hot water valve command rolling average.

At 727, the calculator 720 may calculate a new 30 minute hot water valve command standard deviation based on the hot water command values for the previous 30 minutes. At 729, the calculator 720 may inject the new 30 minute hot water valve command standard deviation back into the data stream 702, where other calculators may use the new 30 minute hot water valve command standard deviation. Thus, as illustrated, a calculator may calculate one new point from two points. Another calculator may calculate two new points from one point.

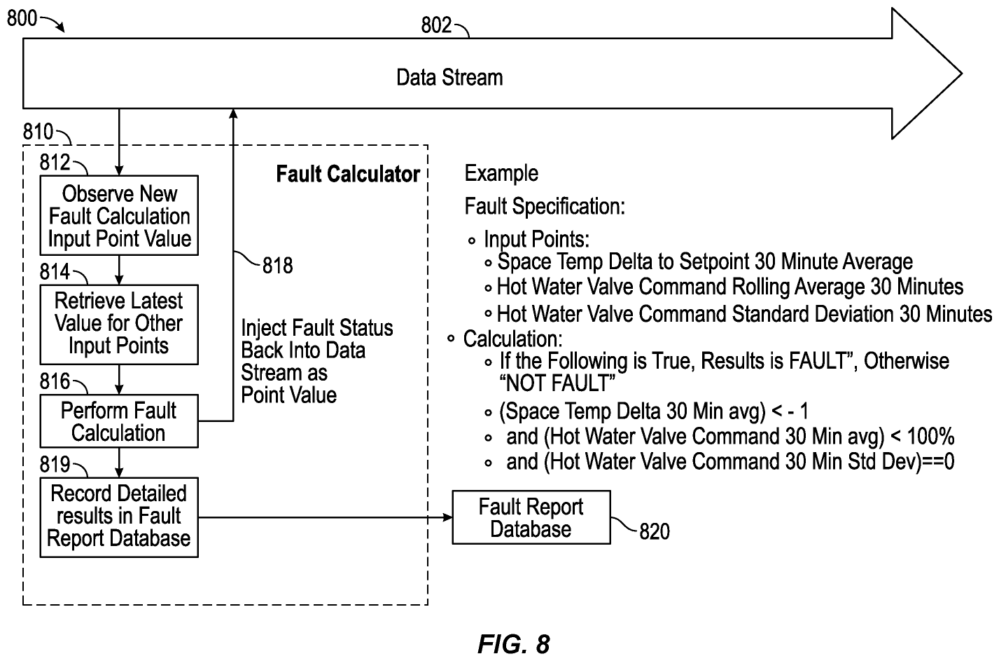

FIG. 8 is a schematic representation of operations 800 of a fault calculator 810, according to aspects of the present disclosure. Fault calculator 810 may be an implementation of calculation event hub trigger 114, orchestrator 116, calculation spawner 130, and/or calculation spawner 140 (see FIG. 1). At 812, the fault calculator 810 may observe (e.g., based on output from a calculation event hub, such as the calculation event hub 110 (see FIG. 1)) that there is a new fault calculation input value. At 814, the fault calculator 810 may retrieve (e.g., from the latest cache values database 120 (see FIG. 1)) latest values for input points of the fault calculator. At 816, the fault calculator 810 may calculate a fault status, based on the latest values for the input points. At 818, the fault calculator 810 may inject the calculated fault status back into the data stream 802. At 819, the fault calculator 810 may record detailed results (e.g., fault status and time of fault) of the fault calculation in the fault report database 820.

An example fault calculation may be described with reference to FIG. 8. The example fault calculation is based on an example fault specification. The example fault specification has three input points, which are a space temperature delta to setpoint 30 minute average, a hot water valve command rolling average 30 minutes, and a hot water valve command standard deviation 30 minutes. The example Fault Specification may be defined as:
If the following is true, then the result is “FAULT”, otherwise “NOT FAULT” (space temp delta 30 min avg)<−1 AND (hot water valve command 30 min avg)<100% AND (hot water valve command 30 min std dev)=0.

As otherwise expressed in pseudo-code:

```
n = NULL;
fault = NULL;
n = ((space temp delta 30 min avg) < −1
  && (hot water valve command 30 min. avg.) < 100%
  && (hot water valve command 30 min. std. dev.) == 0);
if (n == true)
  fault = FAULT;
else
  fault = NOT FAULT;
end;
```

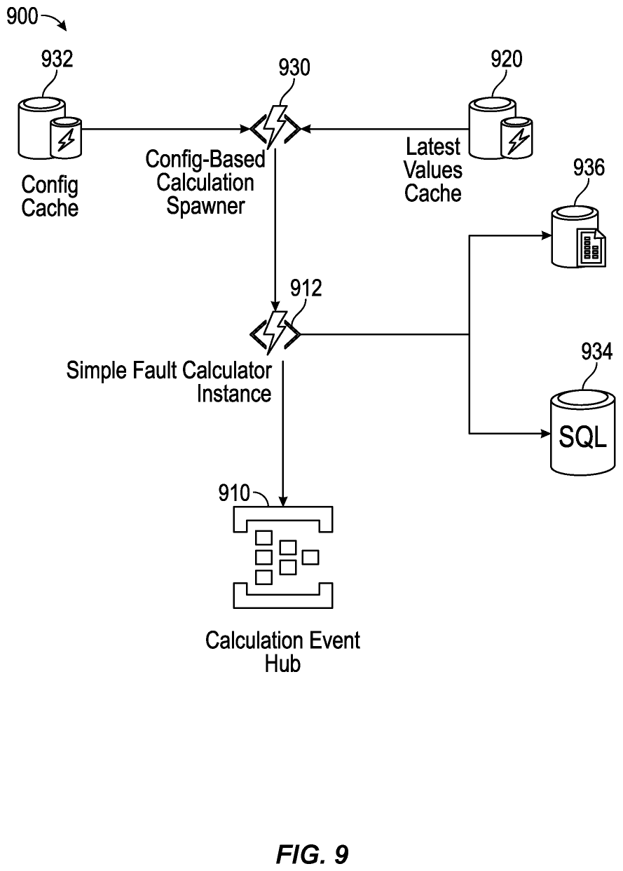

FIG. 9 is a schematic illustration of spawning a configuration-based calculation 900, according to aspects of the present disclosure. When a configuration of a system is changed, the configuration cache database 932 (which may be an example of configuration cache database 132 (see FIG. 1) may be updated. A configuration-based calculation spawner 930 may detect the change to the configuration cache database 932, determine a fault calculation should be spawned, retrieve inputs for the fault calculation from the latest values cache database 920 (which may be an example of the latest values cache database 120 (see FIG. 1)), and may spawn a simple fault calculator instance 912 to perform the fault calculation. The simple fault calculator instance 912 may perform the fault calculation using the inputs, may send results of the fault calculation to a calculation event hub 910 (which may be an example of the calculation event hub 110 (see FIG. 1)), may write logs (which may be unstructured) to a log database 936, and may write structured faults to a fault store database 934 (which may be an example of the fault store 470, (see FIG. 4).

An example set of points, calculations, and faults used in an embodiment of the present disclosure may be described as follows. The example points may include Occupancy Status, Space Temp, Space Temp Set Point, Airflow CFM, Airflow CFM Set Point, Damper Command, Discharge Air Temp, and Hot Water Valve Command. The example calculations may include: Space temp delta to setpoint=(space temp)−(space temp set point); Space temp delta to setpoint rolling average 30 minutes; Hot water valve command rolling average 30 minutes; and Hot water valve command standard deviation 30 minutes. The example faults may include: Occupancy Status Out Of Range, which is true (i.e. in Fault) when the value is not one of [0, 1]; Space Temp Setpoint Out Of Range, which is true when the value is <40 or >100; and Hot Water Valve Not Opening, which is true when (space temp delta 30 min avg)<−1 and (hot water valve command 30 min avg)<100% and (hot water valve command 30 min std dev)=0. The example faults are always enabled, and so their enabling rules may set to True.

According to aspects of the present disclosure, rule based automatic fault detection (AFD) may involve fault calculations that may rely on a set of definitions.

As used herein, a Rule-Based Fault may include a collection of rules that help to detect and diagnose operational deficiencies. Fault evaluation may result in several statuses, which as previously discussed, may include, without limitation: Fault, Not Fault, Disabled, and Blocked.

According to aspects of the present disclosure, rules for AFD may accept Inputs. As used herein, Inputs may include data that may be mapped to the inputs of the fault rules. Within a fault, all rules must have the same inputs. Inputs may have multiple types, including: Equipment reference, Equipment property value, Time Series value, and Static value.

As used herein, Blocking Faults may include external faults that may block the evaluation of the current fault. Blocking Faults may prevent redundant faults from being raised by the system when an operational deficiency is capable of causing multiple fault rules to evaluate as true. Multiple blocking faults may be specified for each fault. If any blocking faults are in “fault” status, then the system may not evaluate the current fault. For example: A variable air volume (VAV) discharge air temperature setpoint (heating mode) fault may be blocked by a fault that indicates that a heating hot water system is in fault for not meeting setpoint.

As used herein, Enabling Rules may include rules that check internal conditions required for the current fault to execute. Multiple enabling rules may be specified for a fault, and all enabling rules must return True for the fault to execute. For example, a modulating outside air damper meeting setpoint airflow fault may have an enabling rule that is true if the unit is in occupied mode. In the example, if the unit is unoccupied, then the modulating outside air damper meeting setpoint airflow fault is not evaluated.

As used herein, Detection Rules are rules that check for the presence of a fault condition. Multiple enabling rules may be specified for each detection rule, and all enabling rules must return True for the fault evaluation to be in fault. For example, a room space temperature fault may have a detection rule that returns True if the space air temperature is out of range.

As used herein, Diagnostic Rules are rules that help indicate the root cause of a fault condition. Multiple diagnostic rules may be specified for each fault. For example, a variable speed pump differential pressure fault may have a diagnostic rule that checks if the pump variable frequency drive (VFD) is in manual mode.

As used herein, Equipment represents a physical piece of equipment, has properties matching haystack protocol, may have a parent equipment, and may have child equipment. According to aspects of the present disclosure, child equipment properties may be accessed via aggregations.

As used herein, a rule may represent an expression that may return a boolean condition (e.g., True or False) based on provided inputs. According to some aspects of the present disclosure, rules in fault specifications may be applications of rules from a Rule Library. The results of applied rules may be kept in a system that is an embodiment of the present disclosure as individual time series. According to aspects of the present disclosure, rules may be executed with input values. Inputs may include, without limitation: an Equipment instance; an Equipment property value reference; a Time series value reference; or a Static value. Example rules in an example rule library may include, without limitation:

Point value above reference plus deadband for time period

Point value below reference minus deadband for time period

Point value inside reference plus/minus deadband range for time period

Point value outside reference plus/minus deadband range for time period

Point value inside min reference/max reference range for time period

Point value outside min reference/max reference range for time period

Point value excessive fluctuation for time period

Point value unchanged for time period

Point value not decreasing for time period

Point value not increasing for time period

Command point value is in override

Equip has reference status/mode for all of time period

Equip does not have reference status/mode for all of time period

Status/mode changes count exceed reference for time period

Point value change of value over detection period is above change detection setpoint in %

Command point is not in override

Point value equal to reference value plus/minus deadband range for time period

According to aspects of the present disclosure, some rules may be Master Rules. Master rules may include special rules that manage the fault process and are the entry point for a fault. Master Rules differ from standard rules in that: master rules may access the fault instance. Master rules may additionally or alternatively generate side effects, such as triggering other rules, sending data to other systems (e.g., for reporting). Furthermore, master rules may return an enumerated value instead of a Boolean to indicate various fault statuses, such as NOT FAULT, FAULT. BLOCKED, and DISABLED.

An example of a fault may be an Air Handling Unit (AHU) Discharge Air Temperature Not Meeting Setpoint (Heating Mode). The example fault may take as inputs an AHU equipment instance, a DAT dead band that may default to 2° F., and a Detection period that defaults to the last 10 minutes. The example fault may include blocking faults that include Heating hot water supply temperature out of range. The example fault may include enabling rules that include: AHU is in enabled mode; and AHU is in heating mode. The example fault may have a detection rule of AHU discharge air temperature below setpoint minus deadband for detection period. The example fault may also have diagnostic rules that include: Heating hot water value below 100% open for detection period; Heating hot water valve not increasing for detection period; and Heating hot water value command is in override.

Another example of a fault may be a Supply Air Static Pressure Sensor Failure. Inputs of this example fault may include: AHU equipment instance and Detection period (default last 10 minutes). This example fault may not have any Blocking Faults. Enabling Rules for this example fault may include AHU is in enabled mode. The Detection Rule for this fault may be AHU static pressure value outside of 0 to 10 inches of water, gauge (in-wg) for the detection period. Diagnostic Rules for this example fault may include: AHU supply fan speed above 99%; AHU supply fan speed below 1%; and AHU supply fan speed unchanged for detection period.

Another example of a fault may be Simultaneous Heating and Cooling. Inputs of this example fault may include the AHU equipment instance and a Detection period (default last 10 minutes). This example fault may not have any Blocking Faults. Enabling Rules for this example fault may include: AHU is in enabled mode. Detection Rules for this fault may include: AHU pre-heat valve above 1%; and AHU cooling valve above 1%. Diagnostic Rules for this example fault may include: AHU pre-heat valve command is in override; AHU cooling valve command is in override; AHU pre-heat valve not changed for detection period; and AHU cooling valve not changed for detection period.

Still another example fault is Chiller Cooling with No Flow. Inputs of this example fault may include: Chiller equipment instance; and Detection period (default last 5 minutes). This example fault may not have any Blocking Faults. Enabling Rules for this example fault may include: Chiller is in enabled mode; and Chiller cooling stage is above 0. Detection Rules for this example fault may include: Chiller supply temp above return temp plus 3 degrees for detection period; and Chiller flow below 1 gallon per minute (gpm) for detection period. Diagnostic Rules for this example fault may include: Chiller supply temp unchanged for detection period; Chiller return temp unchanged for detection period; and Chiller flow below 1 gpm for 1 hour.

Another example fault may be Demand Control Ventilation (DCV) Not Responding (AHU). Inputs for this example fault may include: AHU equipment reference; CO2 sensor time series value; CO2 setpoint time series value; and Detection period (default last 10 minutes). This example fault may not have any Blocking Faults. Enabling Rules for this example fault may include: AHU is enabled; AHU is occupied; DCV is enabled; and AHU outside air damper less than 100% open. Detection Rules for this example fault may include: AHU CO2 sensor value above setpoint for detection period; and AHU outside air damper position not increasing for detection period. Diagnostic Rules for this example fault may include: AHU outside air damper position unchanged for 1 hour; and AHU outside air damper position is in override.

Another example fault may be Demand Control Ventilation Inadequate (AHU). Inputs for this example fault may include: AHU equipment reference; CO2 sensor time series value; CO2 setpoint time series value; and Detection period (default last 10 minutes). This example fault does not have any Blocking Faults. Enabling Rules for this example fault may include: AHU is enabled; AHU is occupied; and DCV is enabled. Detection Rules for this example fault may include: AHU CO2 sensor value above setpoint for detection period; and AHU outside air is 100% open for detection period. This example fault does not have any Diagnostic Rules.

Still another example fault may be AHU Short Cycling (Cooling). Inputs for this example fault may include: AHU equipment reference; Changes threshold (default times); and Detection period (default last 30 minutes). This example fault does not have any Blocking Faults. Enabling Rules for this example fault may include: AHU is enabled. Detection Rules for this example fault may include: AHU mode changes to cooling more than threshold in detection period. This example does not have any Diagnostic Rules.

Still another example fault may be AHU Short Cycling (Heating). Inputs for this example fault may include: AHU equipment reference; Changes threshold (default times); and Detection period (default last 30 minutes). This example fault does not have any Blocking Faults. Enabling Rules for this example fault may include: AHU is enabled. Detection Rules for this example fault may include: AHU mode changes to heating more than threshold in detection period. This example fault does not have any Diagnostic Rules.

Another example fault is AHU Short Cycling (Cooling). Inputs for this example fault may include: AHU equipment reference. This example fault does not have any Blocking Faults. Enabling Rules for this example fault may include: AHU is enabled. Detection Rules for this example fault may include: AHU mode changes to cooling more than threshold in detection period. This example fault does not have any Diagnostic Rules.

Another example fault is Air Handling Unit, Supply Fan VFD 100% and not maintaining SASP-SP. Inputs of this example fault include: AHU Supply Fan Speed Command (VFD Output); AHU Supply Air Static Pressure (SASP); AHU Supply Static Pressure Setpoint SASP-SP); AHU equipment instance; Detection Period (Default: 24 hours); and AHU Static Pressure Difference Tolerance (i.e. 10%). Blocking Faults of this example fault include: AHU Supply Air Static Pressure Sensor is failed or out of range; and AHU Supply Fan VFD Output is in override. Enabling Rules of this example fault include: AHU is in enabled mode; and AHU communications=ok. Detection Rules of this example fault include: AHU Supply Fan VFD Output is greater than 99% for detection period. Diagnostic Rules of this example fault include: AHU Supply Air Static Pressure is less than AHU Supply Air Static Pressure Setpoint for detection period by the amount specified by the AHU Static Pressure Difference Tolerance.

Another example fault is Air Handling Unit, Generic, PID fault—severe oscillation/hunting. Inputs of this example fault include: AHU Supply Fan Output; Detection Period (Default: Last 5 minutes); and Change of Value Over Detection Period Setpoint (Default: 600% change). Blocking Faults of this example fault include: Supply Fan Output feedback sensor is failed or out of range. Enabling Rules of this example fault include: AHU is in enabled mode. Detection Rules of this example fault include: AHU supply fan output point change of value over detection period is above change of value over detection period setpoint. There are no Diagnostic Rules for this example fault.

Another example fault is Air Handling Unit, Supply Air Temp Reset Program at Minimum SAT-SP. Inputs of this example fault include: AHU equipment instance; and Detection Period (Default: 24 hours). This example fault has no Blocking Faults. Enabling Rules of this example fault include: AHU is in enabled mode; AHU communications=ok; and AHU Supply Air Temp Reset is enabled. Detection Rules of this example fault include: Current or Active AHU Supply Air Temperature Set-point is equal to the AHU SAT Reset Minimum SAT Set-point (reference value) for detection period. This example fault has no Diagnostic Rules.

Still another example fault is Air Handling Unit, Supply Air Temp Reset Program at Minimum SAT-SP. Inputs of this example fault include: AHU equipment instance; and Detection Period (Default: 24 hours). This example fault has no Blocking Faults. Enabling Rules of this example fault include: AHU is in enabled mode; AHU is running in occupied mode; AHU communications=ok; and AHU Supply Air Temp Reset is enabled. Detection Rules of this example fault include: Current or Active AHU Supply Air Temperature Set-point is equal to the AHU SAT Reset Minimum SAT Set-point (reference value) for detection period. This example fault does not have Diagnostic Rules.

Another example fault is Air Handling Unit, Supply Air Temp Reset Program at Minimum SAT-SP. Inputs of this example fault include: AHU equipment instance; and Detection Period (Default: 24 hours). This example fault does not have Blocking Faults. Enabling Rules of this example fault include: AHU is in enabled mode; AHU is running in occupied mode; AHU communications=ok; and AHU Supply Air Temp Reset is enabled. Detection Rules of this example fault include: Current or Active AHU Supply Air Temperature Set-point is equal to the AHU SAT Reset Minimum SAT Set-point (reference value) for detection period. This example fault has no Diagnostic Rules.

Another example fault is Air Handling Unit, Supply Air Temp Reset Program at Minimum SAT-SP. Inputs of this example fault include: AHU equipment instance; and Detection Period (Default: 24 hours). This example fault has no Blocking Faults. Enabling Rules of this example fault include: AHU is in enabled mode; AHU is running in occupied mode; AHU communications=ok; and AHU Supply Air Temp Reset is enabled. Detection Rules of this example fault include: Current or Active AHU Supply Air Temperature Set-point is equal to the AHU SAT Reset Minimum SAT Set-point (reference value) for detection period. This example fault does not have Diagnostic Rules.

Another example fault is Air Handling Unit, Supply Air Temp Reset Program at Minimum SAT-SP. Inputs of this example fault include: AHU equipment instance; and Detection Period (Default: 24 hours). This example fault has no Blocking Faults. Enabling Rules of this example fault include: AHU is in enabled mode; AHU is running in occupied mode; AHU communications=ok; and AHU Supply Air Temp Reset is enabled. Detection Rules of this example fault include: Current or Active AHU Supply Air Temperature Set-point is equal to the AHU SAT Reset Minimum SAT Set-point (reference value) for detection period. This example fault has no Diagnostic Rules.

Still another example fault is VAV Discharge Air Temperature Not Meeting Setpoint (Heating Mode). Inputs for this example fault may include: VAV equipment instance; DAT deadband (default 2 F); and Detection period {default last 10 minutes). Blocking Faults for this example fault may include: Heating hot water supply temperature out of range. Enabling Rules for this example fault may include: VAV is in enabled mode; and VAV is in heating mode. Detection Rules for this example fault may include: VAV discharge air temperature below setpoint minus deadband for detection period. Diagnostic Rules for this example fault may include: Heating hot water value below 100% closed for detection period; Heating hot water valve not increasing for detection period; and Heating hot water value command is in override.

Embodiments of the present disclosure may be integrated with building automation systems (BAS) for data collection and may compatible with BACnet and Modbus protocols.

While the foregoing disclosure may describe some example embodiments of a system for data analytics and fault detection in equipment in reference to FIGS. 1-9, FIG. 10 is a block diagram of an example system 1000 for data analytics and fault detection in equipment. One or more of the systems described above in reference to FIGS. 1-9 may implement one or more features, processes, functions, or elements of system 1000. For example, all or a portion of example system 1000 may represent portions of an example system 100 (“system 100”) in FIG. 1.

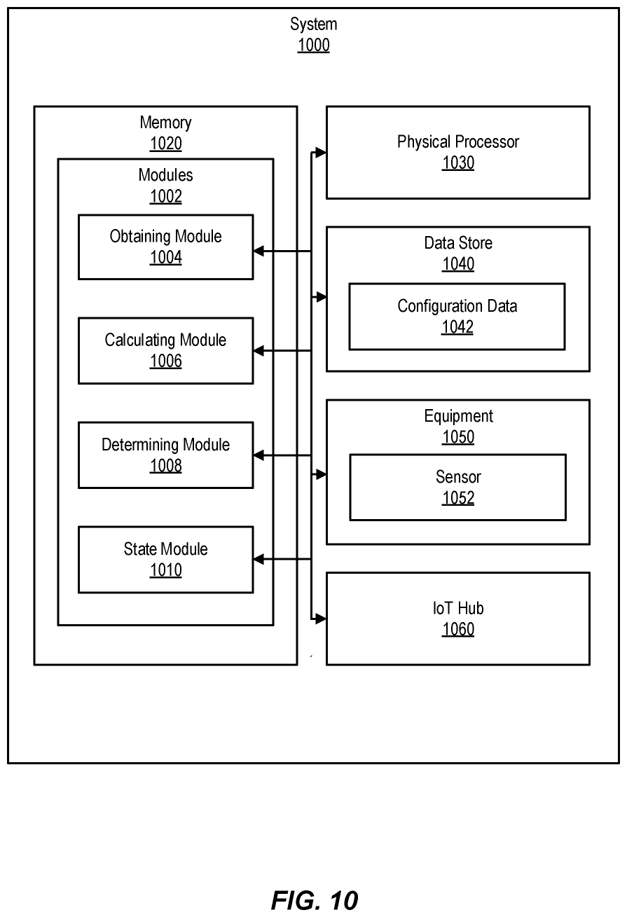

As illustrated in FIG. 10, example system 1000 may include one or more modules 1002 for performing one or more tasks. As explained in greater detail herein, modules 1002 may include an obtaining module 1004 that obtains a datum relevant to an operation of a piece of equipment and a calculating module 1006 that calculates a blocking rule for the piece of equipment. As further shown in FIG. 10, example system 1000 may also include a determining module 1008 that determines, based on the calculation of the blocking rule, whether to calculate a detection rule for the piece of equipment. Example system 1000 may also include a state module 1010 that determines a fault state of the piece of equipment based on at least one of (1) the calculation of the blocking rule, (2) the calculation of the detection rule, and (3) a calculation of an enabling rule for the piece of equipment.

As further illustrated in FIG. 10, example system 1000 may also include one or more memory devices, such as memory 1020. Memory 1020 generally represents any type or form of volatile or non-volatile storage device or medium capable of storing data and/or computer-readable instructions. In one example, memory 1020 may store, load, and/or maintain one or more of modules 1002. Examples of memory 1020 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 10, example system 1000 may also include one or more physical processors, such as physical processor 1030. Physical processor 1030 generally represents any type or form of hardware-implemented processing unit capable of interpreting and/or executing computer-readable instructions. In one example, physical processor 1030 may access and/or modify one or more of modules 1002 stored in memory 1020. Additionally or alternatively, physical processor 1030 may execute one or more of modules 1002 to facilitate data analytics and fault detection in equipment. Examples of physical processor 1030 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also show in FIG. 10, example system 1000 may further include one or more data stores, such as data store 1040, that may receive, store, and/or maintain data. data store 1040 may represent portions of a single data store or computing device or a plurality of data stores or computing devices. In some embodiments, data store 1040 may be a logical container for data and may be implemented in various forms (e.g., a database, a file, a file system, a data structure, etc.). Examples of data store 1040 may include, without limitation, files, file systems, data stores, databases, and/or database management systems such as an operational data store (ODS), a relational database, a No SQL database, a NewSQL database, and/or any other suitable organized collection of data. In at least one example, data store 1040 may include (e.g., store, host, access, maintain, etc.) configuration data 1042 that may include and/or represent any configuration data and/or associated parameters, values, data, and so forth that may be used in a any of the configuration-related processes supported by any of the systems described herein, such as config DB 134, config cache 132, latest values cache 120, and so forth.

Additionally, example system 1000 may also include at least one piece of equipment 1050 (“Equipment 1050” in FIG. 10) that may include, incorporate, and/or be in communication with a sensor 1052. In some examples, piece of equipment 1050 may include or represent any piece of equipment, such as piece of equipment 103. Likewise, sensor 1052 may include or represent any sensor or instrument, such as instrument 107 monitoring piece of equipment 103. Finally, system 1000 may also include an Internet-of-Things hub 1060 (“IoT Hub 1060” in FIG. 10). IoT hub 1060 may include or represent any suitable IoT hub, such as IoT hub 102 in FIG. 1, IoT hub 302 in FIG. 3, and so forth.

FIG. 11 is a flow diagram of an example computer-implemented method 1100 for data analytics and fault detection in equipment. The steps shown in FIG. 11 may be performed by any suitable computer-executable code and/or computing system, including but not limited to system 100 in FIG. 1, system 1000 in FIG. 10, and/or variations or combinations of one or more of the same. In one example, each of the steps shown in FIG. 11 may represent an algorithm whose structure includes and/or is represented by multiple sub-steps, examples of which will be provided in greater detail below.

As illustrated in FIG. 11, at step 1110, one or more of the systems described herein may obtain a datum relevant to an operation of a piece of equipment. For example, as described above, obtaining module 1004 may, as at least part of one or more elements of system 100, cause calculation event hub 110 to obtain, via IoT hub 102, data 105 from an instrument 107 monitoring a piece of equipment 103. Obtaining module 1004 may obtain a datum relevant to an operation of a piece of equipment in any of the ways described herein. For example, the processing system 100 (see FIG. 1) may obtain a discharge air temperature of an air handling unit.

At step 1120, one or more of the systems described herein may calculate a blocking rule for the piece of equipment. For example, as described above, calculating module 1006 may, as part of one or more of the elements included in system 100 (e.g., calculation event hub 110, calculation event hub trigger 114, orchestrator 116, etc.), calculate a rule (e.g., a blocking rule) for a piece of equipment (e.g., piece of equipment 103). Calculating module 1006 may calculate a blocking rule for the piece of equipment in any of the ways described herein. As an example, continuing the example from above, the processing system 100 may determine, based on the blocking rule in step 1120 returning false, to calculate a detection rule, AHU discharge air temperature below setpoint minus deadband for detection period, for the AHU.

At step 1130, one or more of the systems described herein may determine, based on the calculation of the blocking rule, whether to calculate at least one detection rule for the piece of equipment. For example, as described above, determining module 1008 may, as part of one or more of the elements included in system 100 (e.g., calculation event hub 110, calculation event hub trigger 114, orchestrator 116, etc.), determine, based on the calculation of the blocking rule, whether to calculate at least one detection rule for the piece of equipment. Determining module 1008 may determine whether to calculate at least one detection rule for the piece of equipment in any of the ways described herein. By way of illustration, continuing the example from above, the processing system 100 may determine, based on the blocking rule in step 1120 returning false, to calculate a detection rule, AHU discharge air temperature below setpoint minus deadband for detection period, for the AHU.

Continuing with block 1140, one or more of the systems described herein may determine a fault state of the piece of equipment, based on at least one of: the calculation of the blocking rule, the calculation of the detection rule, and a calculation of an enabling rule for the piece of equipment, wherein at least one of the calculation of the blocking rule, the calculation of the detection rule, and the calculation of the enabling rule is dependent on the datum. For example, state module 1010 may, as port of one or more of the elements included in system 100, determine a fault state of the piece of equipment. State module 1010 may determine the fault state of the piece of equipment in any of the ways described herein. As an illustration, continuing the example from above, the processing system 100 determines that the AHU is in a fault state of FAULT, based on the calculation of the blocking rule returning false and the calculation of the detection rule returning true.

The present disclosure thus provides a method of monitoring a piece of equipment, a system for monitoring a piece of equipment that can perform the described method and a computer-readable medium containing instructions for performing the method. By implementation of the described method using the described or similar systems and/or the described or similar computer readable media, a piece of equipment may be automatically monitored and a fault state of the piece of equipment determined.

### Example Embodiments

Example 1: A method comprising (1) obtaining a datum relevant to an operation of a piece of equipment, (2) calculating a blocking rule for the piece of equipment, (3) determining, based on the calculation of the blocking rule, whether to calculate at least one detection rule for the piece of equipment and (4) determining a fault state of the piece of equipment based on at least one of the calculation of the blocking rule, the calculation of the at least one detection rule, and a calculation of an enabling rule for the piece of equipment, wherein at least one of the calculation of the blocking rule, the calculation of the detection rule, and the calculation of the enabling rule is based on the datum.

Example 2: The method of example 1, wherein obtaining the datum relevant to the operation of the piece of equipment comprises obtaining the datum via an Internet of Things (IoT) hub from a sensor associated with the piece of equipment.

Example 3: The method of any of examples 1-2, wherein obtaining the datum relevant to the operation of the piece of equipment further comprises obtaining a timestamp corresponding with the datum and an identifier corresponding to the piece of equipment.

Example 4: The method of any of examples 1-3, wherein calculating the blocking rule comprises retrieving a preconfigured blocking rule for the piece of equipment from a configuration.

Example 5: The method of any of examples 1-4, further comprising determining an order for calculating the blocking rule and the at least one detection rule.

Example 6: The method of any of examples 1-5, wherein (1) the calculation of the blocking rule (a) is based on the datum, and (b) indicates against calculating the at least one detection rule, and (2) determining the fault state comprises determining that the fault state is Blocked.

Example 7: The method of any of examples 1-6, wherein (1) the calculation of the blocking rule indicates in favor of calculating the at least one detection rule, (2) the calculation of the at least one detection rule (a) is dependent on the datum and (b) indicates that the fault state is Fault, and (3) determining the fault state comprises determining that the fault state is Fault.

Example 8: The method of any of examples 1-7, wherein (1) the calculation of the blocking rule indicates in favor of calculating the at least one detection rule, (2) the calculation of the at least one detection rule (a) is dependent on the datum and(b) indicates that the fault state is Not Fault, and (3) determining the fault state comprises determining that the fault state is Not Fault.

Example 9: The method of any of examples 1-8, wherein (1) the method further comprises calculating the enabling rule for the piece of equipment, (2) the enabling rule is dependent on the datum and (3) determining, based on the calculation of the enabling rule, the fault state comprises determining the fault state is Disabled.

Example 10: The method of any of examples 1-9, wherein (1) determining the fault state comprises determining the fault state is Fault and (2) the method further comprises (a) calculating, based on the datum, a diagnostic rule for the piece of equipment and (b) outputting, based on the calculation of the diagnostic rule, an indication of a root cause of the fault state.

Example 11: A system comprising (1) an obtaining module, stored in memory, that obtains a datum relevant to an operation of a piece of equipment, (2) a calculating module, stored in memory, that calculates a blocking rule for the piece of equipment, (3) a determining module, stored in memory, that determines, based on the calculation of the blocking rule, whether to calculate a detection rule for the piece of equipment, (4) a state module, stored in memory, that determines a fault state of the piece of equipment, based on at least one of (a) the calculation of the blocking rule, (b) the calculation of the detection rule, and (c) a calculation of an enabling rule for the piece of equipment, wherein at least one of the calculation of the blocking rule, the calculation of the detection rule, and the calculation of the enabling rule is dependent on the datum, and (5) at least one physical processor that executes the obtaining module, the calculating module, the determining module, and the state module.

Example 12: The system of example 11, wherein the obtaining module obtains the datum relevant to the operation of the piece of equipment by obtaining the datum via an Internet of Things (IoT) hub from a sensor associated with the piece of equipment.

Example 13: The system of any of examples 11-12, wherein the obtaining module obtains the datum relevant to the operation of the piece of equipment by further obtaining a timestamp corresponding with the datum and an identifier corresponding to the piece of equipment.

Example 14: The system of any of examples 11-13, wherein the calculating module calculates the blocking rule by retrieving a preconfigured blocking rule for the piece of equipment from a configuration.

Example 15: The system of any of examples 11-14, wherein (1) the calculating module calculates the blocking rule based on the datum and (2) when the calculation of the blocking rule indicates that the determining module should not calculate the detection rule, the state module determines that the fault state is Blocked.

Example 16: The system of any of examples 11-15, wherein, when the calculation of the blocking rule indicates that the determining module should calculate the detection rule (1) the determining module further calculates the detection rule based on the datum, and (2) the state module determines, based on the calculation of the detection rule, that the fault state is Fault.

Example 17: The system of any of examples 11-16, wherein, when the calculation of the blocking rule indicates that the determining module should calculate the detection rule (1) the determining module further calculates the detection rule based on the datum, and (2) the state module determines, based on the calculation of the detection rule, that the fault state is Not Fault.

Example 18: The system of any of examples 11-17, wherein (1) the determining module further calculates, based on the datum, the enabling rule for the piece of equipment, and (2) the state module determines, based on the calculation of the enabling rule, that the fault state is Disabled.

Example 19: The system of any of examples 11-18, wherein, when the state module determines a fault state of Fault, (1) the calculation module further calculates, based on the datum, a diagnostic rule for the piece of equipment, and (2) the state module further outputs, based on the calculation of the diagnostic rule, an indication of a root cause of the fault state.

Example 20: A non-transitory computer-readable medium comprising computer-readable instructions that, when executed by at least one processor of a computing system, cause the computing system to (1) obtain a datum relevant to an operation of a piece of equipment, (2) calculate a blocking rule for the piece of equipment, (3) determine, based on the calculation of the blocking rule, whether to calculate at least one detection rule for the piece of equipment, and (4) determine a fault state of the piece of equipment based on at least one of the calculation of the blocking rule, the calculation of the at least one detection rule, and a calculation of an enabling rule for the piece of equipment, wherein at least one of the calculation of the blocking rule, the calculation of the detection rule, and the calculation of the enabling rule is based on the datum.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive sensor to be transformed, transform the sensor data, output a result of the transformation to calculate a rule for a piece of equipment, use the result of the transformation to calculate further rules, and store the result of the transformation to calculate further rules. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of” Finally, for ease of use, the terms “including” and “having” (and their derivatives), as used in the specification and claims, are interchangeable with and have the same meaning as the word “comprising.”

What is claimed is:

1. A method comprising:
obtaining a datum relevant to an operation of a piece of equipment;
calculating a blocking rule for the piece of equipment;
determining, based on the calculation of the blocking rule, whether to calculate at least one detection rule for the piece of equipment; and
determining a fault state of the piece of equipment based on at least one of the calculation of the blocking rule, the calculation of the at least one detection rule, and a calculation of an enabling rule for the piece of equipment, wherein at least one of the calculation of the blocking rule, the calculation of the detection rule, and the calculation of the enabling rule is based on the datum.

2. The method of claim 1, wherein obtaining the datum relevant to the operation of the piece of equipment comprises obtaining the datum via an Internet of Things (IoT) hub from a sensor associated with the piece of equipment.

3. The method of claim 1, wherein obtaining the datum relevant to the operation of the piece of equipment further comprises obtaining a timestamp corresponding with the datum and an identifier corresponding to the piece of equipment.

4. The method of claim 1, wherein calculating the blocking rule comprises retrieving a preconfigured blocking rule for the piece of equipment from a configuration.

5. The method of claim 1, further comprising determining an order for calculating the blocking rule and the at least one detection rule.

6. The method of claim 1, wherein:
the calculation of the blocking rule:
is based on the datum; and
indicates against calculating the at least one detection rule, and
determining the fault state comprises determining that the fault state is Blocked.

7. The method of claim 1, wherein:
the calculation of the blocking rule indicates in favor of calculating the at least one detection rule;
the calculation of the at least one detection rule:
is dependent on the datum; and
indicates that the fault state is Fault; and
determining the fault state comprises determining that the fault state is Fault.

8. The method of claim 1, wherein:
the calculation of the blocking rule indicates in favor of calculating the at least one detection rule;
the calculation of the at least one detection rule:
is dependent on the datum; and
indicates that the fault state is Not Fault; and
determining the fault state comprises determining that the fault state is Not Fault.

9. The method of claim 1, wherein:
the method further comprises calculating the enabling rule for the piece of equipment;
the enabling rule is dependent on the datum; and
determining, based on the calculation of the enabling rule, the fault state comprises determining the fault state is Disabled.

10. The method of claim 1, wherein:
determining the fault state comprises determining the fault state is Fault; and
the method further comprises:
calculating, based on the datum, a diagnostic rule for the piece of equipment; and
outputting, based on the calculation of the diagnostic rule, an indication of a root cause of the fault state.

11. A system comprising:
an obtaining module, stored in memory, that obtains a datum relevant to an operation of a piece of equipment;
a calculating module, stored in memory, that calculates a blocking rule for the piece of equipment;
a determining module, stored in memory, that determines, based on the calculation of the blocking rule, whether to calculate a detection rule for the piece of equipment;
a state module, stored in memory, that determines a fault state of the piece of equipment, based on at least one of: the calculation of the blocking rule, the calculation of the detection rule, and a calculation of an enabling rule for the piece of equipment, wherein at least one of the calculation of the blocking rule, the calculation of the detection rule, and the calculation of the enabling rule is dependent on the datum; and
at least one physical processor that executes the obtaining module, the calculating module, the determining module, and the state module.

12. The system of claim 11, wherein the obtaining module obtains the datum relevant to the operation of the piece of equipment by obtaining the datum via an Internet of Things (IoT) hub from a sensor associated with the piece of equipment.

13. The system of claim 11, wherein the obtaining module obtains the datum relevant to the operation of the piece of equipment by further obtaining a timestamp corresponding with the datum and an identifier corresponding to the piece of equipment.

14. The system of claim 11, wherein the calculating module calculates the blocking rule by retrieving a preconfigured blocking rule for the piece of equipment from a configuration.

15. The system of claim 11, wherein:
the calculating module calculates the blocking rule based on the datum; and
when the calculation of the blocking rule indicates that the determining module should not calculate the detection rule, the state module determines that the fault state is Blocked.

16. The system of claim 11, wherein:
when the calculation of the blocking rule indicates that the determining module should calculate the detection rule:
the determining module further calculates the detection rule based on the datum; and
the state module determines, based on the calculation of the detection rule, that the fault state is Fault.

17. The system of claim 11, wherein:
when the calculation of the blocking rule indicates that the determining module should calculate the detection rule:
the determining module further calculates the detection rule based on the datum; and
the state module determines, based on the calculation of the detection rule, that the fault state is Not Fault.

18. The system of claim 11, wherein:
the determining module further calculates, based on the datum, the enabling rule for the piece of equipment; and
the state module determines, based on the calculation of the enabling rule, that the fault state is Disabled.

19. The system of claim 11, wherein:
when the state module determines a fault state of Fault:
the calculation module further calculates, based on the datum, a diagnostic rule for the piece of equipment; and
the state module further outputs, based on the calculation of the diagnostic rule, an indication of a root cause of the fault state.

20. A non-transitory computer-readable medium comprising computer-readable instructions that, when executed by at least one processor of a computing system, cause the computing system to:
obtain a datum relevant to an operation of a piece of equipment;
calculate a blocking rule for the piece of equipment;
determine, based on the calculation of the blocking rule, whether to calculate at least one detection rule for the piece of equipment; and
determine a fault state of the piece of equipment based on at least one of the calculation of the blocking rule, the calculation of the at least one detection rule, and a calculation of an enabling rule for the piece of equipment, wherein at least one of the calculation of the blocking rule, the calculation of the detection rule, and the calculation of the enabling rule is based on the datum.
